(19) United States
(12) Patent Application Publication
(10) Pub. No.: US 2007/0270623 A1
(43) Pub. Date: Nov. 22, 2007

(54) Alkylation reaction vessel

(75) Inventor: James T. Merrill, Katy, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/413,457

(22) Filed: Apr. 28, 2006

(51) Int. Cl. B01J 8/02

(52) U.S. Cl. 585/446; 422/189; 422/239; 422/238; 422/211

(57) ABSTRACT

Alkylation systems and methods of forming alkyl aromatic compounds are described herein. The alkylation systems generally include a reaction vessel including a first reaction zone adapted to receive an input stream having a first aromatic compound, wherein the first reaction zone includes an alkylation catalyst. The reaction vessel further includes a second reaction zone in communication with the first reaction zone, wherein the second reaction zone is adapted to receive an alkylating agent and pass the alkylating agent therethrough to the first reaction zone to contact the input stream in the presence of the alkylation catalyst to form an output stream including a second aromatic compound.

### FIELD

Embodiments of the present invention generally relate to alkylation systems. In particular, embodiments of the invention generally relate to alkylation reaction vessels.

### BACKGROUND

While conventional alkylation reaction vessels provide for sufficient throughput and high rates of reaction, such reaction vessels generally operate at high localized temperatures. Unfortunately, such high temperatures generally increase the rate of catalyst deactivation. The high temperatures also result in difficulties with selectivity control.

Therefore, a need exists for an alkylation vessel that maintains the benefits of conventional alkylation vessels but reduces the amount of catalyst deactivation and/or provides greater control of selectivity.

### SUMMARY

Embodiments of the present invention include alkylation systems. The alkylation systems generally include a reaction vessel including a first reaction zone adapted to receive an input stream having a first aromatic compound, wherein the first reaction zone includes an alkylation catalyst. The reaction vessel further includes a second reaction zone in communication with the first reaction zone, wherein the second reaction zone is adapted to receive an alkylating agent and pass the alkylating agent therethrough to the first reaction zone to contact the input stream in the presence of the alkylation catalyst to form an output stream including a second aromatic compound.

Embodiments of the invention further include methods method of forming ethylbenzene. The methods generally include providing benzene to a first reaction zone at a first pressure, providing ethylene to a second reaction zone at a second pressure, wherein the second pressure is higher than the first pressure and is adapted to transfer the ethylene from the second reaction zone into the first reaction zone and contacting the benzene with the ethylene in the presence of an alkylation catalyst within the first reaction zone to form ethylbenzene.

### BRIEF DESCRIPTION OF DRAWINGS

FIGS. 1, 2 and 3 illustrate embodiments of alkylation systems.

FIGS. 4A and 4B illustrate cross sectional views of alkylation vessels.

### DETAILED DESCRIPTION

Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

The term “selectivity” refers to the percentage of input/reactant converted to a desired output/product.

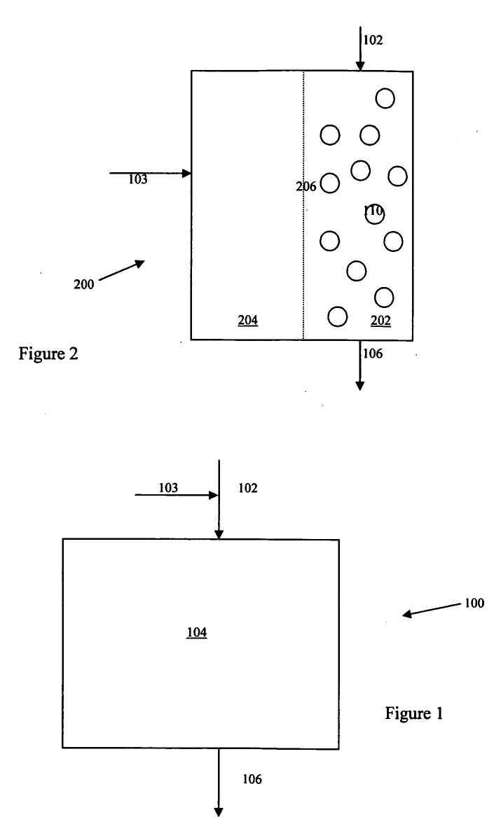

FIG. 1 illustrates a schematic block diagram of an embodiment of an alkylation process 100. Although not shown herein, the process stream flow may be modified based on unit optimization so long as the modification complies with the spirit of the invention, as defined by the claims. For example, any process stream may be split into multiple process streams. Also, additional process equipment, such as heat exchangers, may be employed throughout the processes described herein and such placement is generally known to one skilled in the art. Further, while described below in terms of primary components, the streams indicated below may include any additional components as known to one skilled in the art.

The process 100 generally includes supplying an input stream 102 to an alkylation system 104. The alkylation system 104 is generally adapted to contact the input stream 102 with an alkylation catalyst to form an alkylation output stream 106. In addition to the input stream 102, an additional input, such as an alkylating agent, is generally supplied to the alkylation system 104 via line 103.

The input stream 102 generally includes a first aromatic compound. The first aromatic compound may include substituted or unsubstituted aromatic compounds. If present, the substituents on the first aromatic compounds may be independently selected from alkyl, aryl, alkaryl, alkoxy, aryloxy, cycloalkyl, halide and/or other groups that do not interfere with the alkylation reaction, for example. Examples of substituted first aromatic compounds generally include toluene, xylene, isopropylbenzene, normal propylbenzene, alpha-methylnaphthalene, ethylbenzene, mesitylene, durene, cymene, butylbenzene, pseudocumene, o-diethylbenzene, m-diethylbenzene, p-diethylbenzene, isoamylbenzene, isohexylbenzene, pentaethylbenzene, pentamethylbenzene, 1,2,3,4-tetraethylbenzene, 1,2,3,5-tetramethylbenzene, 1,2,4-triethylbenzene, 1,2,3-trimethylbenzene, m-butyltoluene, p-butyltoluene, 3,5-diethyltoluene, o-ethyltoluene, p-ethyltoluene, m-propyltoluene, 4-ethyl-m-xylene, dimethylnaphthalenes, ethylnaphthalene, 2,3-dimethylanthracene, 9-ethylanthracene, 2-methylanthracene, o-methylanthracene, 9,10-dimethylphenanthrene and 3-methyl-phenanthrene. Further examples of aromatic compounds include hexylbenzene, nonylbenzene, dodecylbenzene, pentadecylbenzene, hexyltoluene, nonyltoluene, dodecyltoluene and pentadecytoluene. In one embodiment, the first aromatic compound includes one or more hydrocarbons, such as benzene, naphthalene, anthracene, naphthacene, perylene, coronene and phenanthene, for example. In another embodiment, the first aromatic compound includes benzene. The benzene may be supplied from a variety of sources, such as a fresh benzene source and/or a variety of recycle sources, for example.

As used herein, the term “fresh benzene source” refers to a source including at least about 95 wt. % benzene, at least about 98 wt. % benzene or at least about 99 wt. % benzene, for example.

The alkylating agent may include olefins (e.g., ethylene, propylene, butene and pentene), alcohols (e.g., methanol, ethanol, propanol, butanol and pentanol), aldehydes (e.g., formaldehyde, acetaldehyde, propionaldehyde, butyraldehyde and n-valeraldehyde) and/or alkyl halides (e.g, methyl chloride, ethyl chloride, propyl chloride, butyl chloride and pentyl chloride), for example. In one embodiment, the alkylating agent includes a mixture of light olefins, such as mixtures of ethylene, propylene, butene and/or pentenes, for example. In another embodiment, the alkylating agent includes ethylene.

In addition to the first aromatic compound and the alkylating agent, the input stream 102 and/or line 103 may further include other compounds in minor amounts (e.g., sometimes referred to as poisons or inactive compounds,) such as C₇ aliphatic compounds and/or nonaromatic compounds, for example. In one embodiment, the input stream 102 includes less than about 3% of such compounds or less than about 1%, for example.

The alkylation output 106 generally includes a second aromatic compound formed from the reaction of the first aromatic compound and the alkylating agent in the presence of the alkylation catalyst, for example. The specific composition of the second aromatic compound depends upon the specific first aromatic compound and the alkylating agent. In a specific embodiment, the first aromatic compound includes benzene and the first alkylating agent includes ethylene. Therefore, the second aromatic compound includes ethylbenzene, for example.

In one embodiment, the molar ratio of benzene to ethylene entering the alkylation system 104 may be from about 1:1 to about 30:1, or from about 1:1 to about 20:1 or from about 5:1 to about 15:1, for example.

In a specific embodiment, the second aromatic compound including benzene is recovered through line 106 and recycled (not shown) as input to the alkylation system 104. While it is generally known in the art to recycle portions of the output 106 externally, it is contemplated that the reaction vessel may be adapted for internal recirculation of at least a portion of the output 106.

In addition, the alkylation system 104 may include one or more reaction vessels (not shown.)

FIG. 2 illustrates an embodiment of an alkylation vessel 200. The alkylation vessel 200 generally includes a first reaction zone 202 and a second reaction zone 204, which are generally separated by a wall 206. The first reaction zone 202 is generally adapted to receive the input stream 102. The second reaction zone is generally adapted to receive the alkylating agent 103. As stated previously, any process stream may be split into multiple process streams. For example, the alkylating agent and/or the input stream may be fed to the reaction vessel 200 via a plurality of inlet lines (not shown).

The first reaction zone 202 includes an alkylation catalyst 110 disposed therein. The alkylation catalyst 110 may include a molecular sieve catalyst, for example. Such molecular sieve catalyst may include zeolite beta, zeolite Y, zeolite MCM-22, zeolite MCM-36, zeolite MCM-49 or zeolite MCM-56, for example. In one embodiment, the catalyst is a zeolite beta having a silica to alumina molar ratio (expressed as SiO₂:Al₂O₃) of from about 10 to about 200 or about 20 to about 50, for example. In one embodiment, the zeolite beta may have a low sodium content, e.g., less than about 0.2 wt. % expressed as Na₂O, or less than about 0.02 wt. %, for example. The sodium content may be reduced by any method known to one skilled in the art, such as through ion exchange, for example. (See, U.S. Pat. No. 3,308,069 and U.S. Pat. No. 4,642,226 (formation of zeolite beta), U.S. Pat. No. 4,185,040 (formation of zeolite Y), U.S. Pat. No. 4,992,606 (formation of MCM-22), U.S. Pat. No. 5,258,565 (formation of MCM-36), WO 94/29245 (formation of MCM-49) and U.S. Pat. No. 5,453,554 (formation of MCM-56.))

The alkylation catalyst may optionally be bound to, supported on or extruded with any support material. For example, the alkylation catalyst may be bound to a support to increase the catalyst strength and attrition resistance. The support material may include alumina, silica, aluminosilicate, titanium and/or clay, for example.

Although separated by a wall 206, the first reaction zone 202 is in fluid communication with the second reaction zone 204. As used herein, the term “communication” refers to the ability of fluid to flow from one reaction zone into another. Therefore, at least a portion of the wall 206 may be formed of a porous material, for example.

Embodiments generally include providing and maintaining directional flow of the alkylating agent from the second reaction zone 204 into the first reaction zone 202, rather than flow of the input stream 103 into the second reaction zone 204. Therefore, the pressure of the alkylating agent (second pressure) within the second reaction zone 204 may be higher than the pressure of the input stream 102 (first pressure), for example. The second pressure may be selected to provide a minimal flow of alkylating agent across the wall 206 relative to the flow of the input stream on the first reaction zone side of the wall 206 and sufficient to permit reaction of the first aromatic compound in the input stream 102 within the first reaction zone 202 with the alkylating agent passing therethrough.

In one embodiment, the pressure differential (difference between the first pressure and the second pressure) may vary along the length of the wall 206. For example, the pressure differential may decrease in the direction of flow of input (assuming that the second pressure remains constant.) Therefore, the wall 206 may have a continually decreasing porosity along the same direction. This may be accomplished by any method known to one skilled in the art, such as with a sleeve, which may be adjusted, for example.

Alternatively, the directional flow of the alkylating agent may be controlled by a wall 206 being formed of a selective porosity material. The selective material may provide for flow of the reactants in only a single direction (e.g., from the second reaction zone 204 into the first reaction zone 202.)

The porous material may be formed a material having a controlled porosity, for example. Such materials are generally known to one skilled in the art. For example, in one embodiment, the porous material includes a sintered metal. In one embodiment, the porous material includes a high porosity material which has been coated with a second material to control the porosity. For example, a porous stainless steel material may be coated with a non-reactive ceramic material, such as zirconia. See, U.S. Pat. No. 5,583,240, which is incorporated by reference herein.

The wall 206 is adapted to control the flow of alkylating agent 103 therethrough into the first reaction zone 202. Such control may be achieved by adjusting the porosity of the porous material and/or the pressure differential between the first reaction zone 202 and the second reaction zone 204.

For example, the porosity may be selected to provide a volumetric flow rate of alkylating agent through the wall 206 that results in the desired rate of reaction (determined by individual process parameters) between the reactants (e.g., alkylating agent and first aromatic compound.) Accordingly, portions of the wall 206 may have differing porosities. For example, a first portion of the wall may have a first porosity while a second portion of the wall may have a second porosity.

In addition, the temperature range (lowest temperature in the reaction vessel to the highest temperature in the reaction vessel) maintained in the reaction vessel 200 (e.g., localized catalyst temperatures) may range from the lowest temperature at which the alkylating agent will still pass through the wall 104 and at which both reactants will be in the desired states. The upper end of the temperature range is generally lower than that used in conventional alkylation systems. Therefore, such a reaction vessel generally provides for improved selectivity control in addition to a reduction in catalyst deactivation rates.

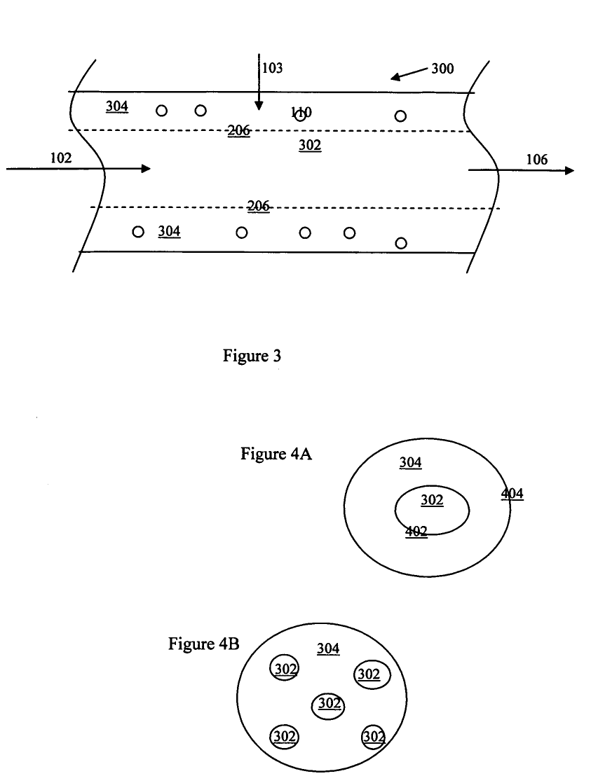

Specific non-limiting embodiments are illustrated in FIGS. 3, 4A and 4B. The reaction vessel 300 includes a second reaction zone 302 disposed within a first reaction zone 304. Such embodiments may include housing the second reaction zone 302 with the first reaction zone 304. In such an embodiment, the second reaction zone 302 may result in a liquid hourly space velocity (LHSV) of from about 10 hr⁻¹ to about 100 hr⁻¹ or from about 30 hr⁻¹ to about 70 hr⁻¹, for example.

One or more of the reaction zones may be in the form of tubular sections, for example. See, FIG. 4A illustrating a cross sectional view of a single tubular 402 section housed within a shell 404. The tubular section 402 is formed by the wall 206 described in detail above. The second reaction zone 302 may include a plurality of reaction zones, each reaction zone being housed by the first reaction zone 304. See, FIG. 4B. For example, the second reaction zone 302 may include from 2 to 50 individual reaction zones, with each zone being identified by alkylating agent passing therethrough independent of the flow of input through another reaction zone. Further, each second reaction zone is at least partially isolated from one another by first one or more first reaction zones. Although illustrated in the figures as alkylating agent flowing through reaction zone 302 (e.g., the plurality of tubular sections,) it is contemplated that the input stream may flow through reaction zone 302 in one or more embodiments.

While the foregoing is directed to embodiments of the present invention, other and further embodiments of the invention may be devised without departing from the basic scope thereof and the scope thereof is determined by the claims that follow.

What is claimed is:

1. An alkylation system comprising:
a reaction vessel comprising:
a first reaction zone adapted to receive an input stream comprising a first aromatic compound, wherein the first reaction zone comprises an alkylation catalyst;
a second reaction zone in fluid communication with the first reaction zone, wherein the second reaction zone is adapted to receive an alkylating agent and pass the alkylating agent therethrough to the first reaction zone to contact the input stream in the presence of the alkylation catalyst to form an output stream comprising a second aromatic compound.

2. The system of claim 1, wherein the second reaction zone is formed of a porous material.

3. The system of claim 1, wherein the first reaction zone houses the second reaction zone.

4. The system of claim 1, wherein the alkylation catalyst comprises a zeolite catalyst.

5. The system of claim 1, wherein the reaction vessel comprises a tubular section housed within a shell.

6. The system of claim 1, wherein the first reaction zone and the second reaction zone are separated by a wall.

7. The system of claim 6, wherein at least a portion of the wall is porous.

8. The system of claim 6, wherein the wall comprises a sintered metal.

9. The system of claim 2, wherein the porous material comprises one or more porous tubes separating the first reaction zone from the second reaction zone.

10. The system of claim 1, wherein the first aromatic compound comprises benzene, the alkylating agent comprises ethylene and the second aromatic compound comprises ethylbenzene.

11. The system of claim 1, wherein the first reaction zone comprises a liquid hourly space velocity of from about 3 hr⁻¹ to about 70 hr⁻¹.

12. A method of forming ethylbenzene comprising:
providing benzene to a first reaction zone at a first pressure;
providing ethylene to a second reaction zone at a second pressure, wherein the second pressure is higher than the first pressure and is adapted to transfer the ethylene from the second reaction zone into the first reaction zone;
contacting the benzene with the ethylene in the presence of an alkylation catalyst within the first reaction zone to form ethylbenzene.

13. The method of claim 12, wherein the second pressure is maintained at a pressure that is higher than the first pressure at corresponding locations along a length of the reaction zones to inhibit the flow of benzene into the second reaction zone.

14. The system of claim 12, wherein the alkylation catalyst comprises a zeolite catalyst.

15. The system of claim 12, wherein the first reaction zone and the second reaction zone are separated by a wall.

16. The system of claim 15, wherein at least a portion of the wall is porous.

17. The system of claim 16, wherein the wall comprises a sintered metal.

18. The system of claim 15, wherein a first portion of the wall comprises a first porosity and a second portion of the wall comprises a second porosity.

19. The system of claim 18, wherein the second portion is in proximity with a withdrawal point for the ethylbenzene and wherein the second porosity is less than the first porosity.

20. The system of claim 12, wherein the first reaction zone comprises a liquid hourly space velocity of from about 3 hr⁻¹ to about 70 hr⁻¹.
